(19) United States
(12) Patent Application Publication
(10) Pub. No.: US 2026/0179130 A1
(43) Pub. Date: Jun. 25, 2026

(54) Method and System for Generating a User Specific Content

(71) Applicant: Glance InMobi Pte. Ltd.

(72) Inventors: Chandrashekhar Iyer, Bangalore (IN); Karthik Sai Marala, Bangalore (IN); K.V. Nanjaraje Urs, Bengaluru (IN); Anchala Tarun Kumar, Nellore (IN); Manish Kumar Gupta, Bengaluru (IN); Manan Saxena, Bengaluru (IN); Vishal Gopal, Bengaluru (IN); Karthik P, Bangalore (IN); Sanjay Kumar, Bengaluru (IN)

(73) Assignee: Glance InMobi Pte. Ltd., (omitted)

(21) Appl. No.: 19/046,335

(22) Filed: Feb. 5, 2025

(30) Foreign Application Priority Data
Dec. 20, 2024 (IN) 2024111101359

(51) Int. Cl. G06Q 30/0601; G06Q 30/0241; G06Q 30/0282; G06T 11/60

(52) U.S. Cl. CPC G06Q 30/0621; G06Q 30/0277

(57) ABSTRACT

The present disclosure relates to a method and system for generating a user specific content. The method comprises receiving, by a processing unit, a user specific input data, a base content, and an e-commerce data. The method further comprises extracting, by the processing unit, a set of features from the user specific input data. Further, the method comprises altering, by the processing unit, the base content based on the e-commerce data and the set of features. Furthermore, the method comprises generating, by the processing unit, the user specific content based on the altering, wherein the user specific content comprises at least one of a user specific visual media, and a user specific audio-visual media.

Embodiments of the present disclosure generally relate to methods and systems of image processing. More particularly the present disclosure relates to methods and systems for generating user specific content.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

When consuming content on media rendering devices like televisions (TVs), users experience emotions which make them relate to the content, and also in turn might enable them to imagine scenarios. For instance, while seeing a family holiday album, a user might imagine the next family holiday, or while viewing their favorite team winning a game, they might imagine them being present in the moment to celebrate the win. The content may be a generic content e.g., news, sports, movies etc., or a personal content e.g., family photos.

Currently, with the advent of Generative artificial intelligence (AI), there are solutions available in the market that transform users' images into visuals based on their input prompts. For e.g., users can upload their photos and prompt systems to “transform them into a football player.” However, the prior arts heavily rely on explicit inputs from the users. Furthermore, these existing concepts are isolated and fall short of integrating into content experiences, which form a key part of a user's engagement on connected devices. These technologies are also absent from devices like connected television (TV). Lastly, the existing solutions just act directly on the users' prompts and fall short of exposing the multitude of future and/or imaginary scenarios to the users.

In order to solve the above and other related inherent problems of the existing arts, it is an imperative need to provide an efficient method and system for generating a user specific content.

### OBJECTS OF THE DISCLOSURE

Some of the objects of the present disclosure which at least one embodiment disclosed herein satisfies are listed herein below.

It is an object of the present disclosure to provide a system and a method for generating a user specific content.

It is another object of the present disclosure to provide a solution that can provide to a user of a user device a virtual experience of real-life moments.

It is another object of the present disclosure to provide a solution that can provide to a user of a user device an option to imagine a future scenario and/or fantasies via generated media content like images or videos.

It is another object of the present disclosure to provide a solution that can provide to a user of a user device an option to relive memories of past in present via generated media content like images or videos.

It is another object of the present disclosure to provide a solution that can generate personalized visuals related to content preferred by users of user devices, with said users being a part of the visuals.

It is another object of the present disclosure to provide a solution that can identify non-human object(s) in an image that a user of a user device may want to purchase.

It is another object of the present disclosure to provide a solution that can search in an e-commerce catalog for one or more products matching non-human object(s) present in an image or a video.

It is yet another object of the present disclosure to provide a solution that can provide, on a user device, a link to purchase product(s) matching with non-human object(s) present in a media rendered on the user device, wherein the media is generated at the user device to provide a user of the user device virtual experience of real-life moments.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for generating a user specific content. The method comprises receiving, by a processing unit, a user specific input data, a base content, and an e-commerce data. The method further comprises extracting, by the processing unit, a set of features from the user specific input data. Further, the method comprises altering, by the processing unit, the base content based on the e-commerce data and the set of features. Furthermore, the method comprises generating, by the processing unit, the user specific content based on the altering, wherein the user specific content comprises at least one of a user specific visual media, and a user specific audio-visual media.

In an exemplary aspect of the present disclosure, the e-commerce data is related to the base content and the user specific input data.

In an exemplary aspect of the present disclosure, the base content is at least one of a visual media and an audio-visual media, related to at least one of a trending event, a news, a sport, a geographical area, a weather condition, an entertainment related event, and an image of one or more users of a user device.

In an exemplary aspect of the present disclosure, the user specific input data is received as at least one of an automatic input, and a manual input from one or more users of a user device, and wherein the user specific input data comprises a set of images related to at least one of a person, an animal, and an object and at least one of a user related data, a user preference data, a content usage pattern information, and a content engagement information.

In an exemplary aspect of the present disclosure, the set of features comprises at least one of a set of facial parameters, a set of age-related parameters, a set of gender related parameters, a set of environment related parameters, a set of non-human object related parameters, and a set of characteristics related parameters.

In an exemplary aspect of the present disclosure, the set of features are extracted by the processing unit using a first artificial intelligence based sub-system.

In an exemplary aspect of the present disclosure, the altering, by the processing unit, the base content further comprises: 1) generating, by the processing unit using a second artificial intelligence based sub-system, one or more suggestions based on the user specific input data, 2) providing, by the processing unit, the one or more suggestions on a user device, 3) receiving, by the processing unit from the user device, a response to the one or more suggestions, and 4) altering, by the processing unit, the base content based on the response.

In an exemplary aspect of the present disclosure, the user specific content comprises one or more links to purchase one or more items visible in the user specific content, and wherein the one or more links are added during the altering, and the one or more links are identified based on the e-commerce data.

In an exemplary aspect of the present disclosure, the user specific content comprises one or more advertisements (Ads), and wherein the one or more Ads are added during the altering, and the one or more Ads are identified based on at least one of the user specific input data, the base content, and the e-commerce data.

In an exemplary aspect of the present disclosure, the method further comprises: 1) providing, by the processing unit, the generated user specific content on a user device, 2) receiving, by the processing unit from the user device, a user feedback on one or more portions of the generated user specific content, and 3) updating, by the processing unit, the generated user specific content based on the user feedback.

In an exemplary aspect of the present disclosure, the user device is a smart television.

In an exemplary aspect of the present disclosure, for generating the user specific content, the method comprises performing a suitability check for the user specific content.

Another aspect of the present disclosure may relate to a system for generating a user specific content. The system comprises a storage unit and a processing unit connected to at least the storage unit. The processing unit is configured to receive a user specific input data, a base content, and an e-commerce data. The processing unit is further configured to extract a set of features from the user specific input data. Further, the processing unit is configured to alter the base content based on the e-commerce data and the set of features. Furthermore, the processing unit is configured to generate the user specific content based on the altering, wherein the user specific content comprises at least one of a user specific visual media, and a user specific audio-visual media.

Yet another object of the present disclosure may relate to a non-transitory computer readable storage medium storing one or more instructions for generating a user specific content, the instructions include executable code which, when executed by one or more units of a system, causes a processing unit of the system to receive a user specific input data, a base content and an e-commerce data. Further, the executable code when executed causes the processing unit to extract a set of features from the user specific input data. Further, the executable code when executed causes the processing unit to alter the base content based on the e-commerce data and the set of features. Furthermore, the executable code when executed causes the processing unit to generate the user specific content based on the altering, wherein the user specific content comprises at least one of a user specific visual media, and a user specific audio-visual media.

### BREIF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the disclosure. All sub-components within a component may be connected to each other, unless otherwise indicated.

FIG. 1 illustrates an exemplary block diagram of a system for generating user specific content, in accordance with the exemplary embodiments of the present disclosure.

FIG. 2 illustrates an exemplary flow diagram of a method for generating user specific content, in accordance with the exemplary embodiments of the present disclosure.

FIG. 3 illustrates an exemplary flow diagram for generating user specific content, in accordance with the exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter may each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor. Furthermore, to execute certain operations, the processing unit/processor as disclosed in the present disclosure may include one or more Central Processing Unit (CPU) and one or more Graphics Processing Unit (GPU), selected based on said certain operations. Furthermore, the graphics processing unit (GPU) is a specialized electronic circuit designed to rapidly manipulate and alter a memory to accelerate the creation of images in a frame buffer intended for output to a display device.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit can be any type of storage unit such as Cloud or CDN (content delivery network) storage, public, shared, private, telecommunications operator-based storage, or any other type of storage known in the art or may be developed in future that may be obvious to a person skilled in the art for implementing the features of the present disclosure. The storage unit stores at least the data that may be required by one or more units of a server/system/user device to perform their respective functions.

A ‘smart computing device’ or ‘user device’ refers to any electrical, electronic, electromechanical equipment or a combination thereof. Smart computing devices may include, but not limit to, a mobile phone, smart phone, pager, laptop, a general-purpose computer, desktop, personal digital assistant, tablet computer, mainframe computer, smart television, gaming consoles, media streaming devices, or any other computing device as may be obvious to a person skilled in the art for implementing the features as disclosed in the present disclosure. In general, a smart computing device is a digital, user configured, computer networked device that can operate autonomously. A smart computing device is one of the appropriate systems for storing data.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

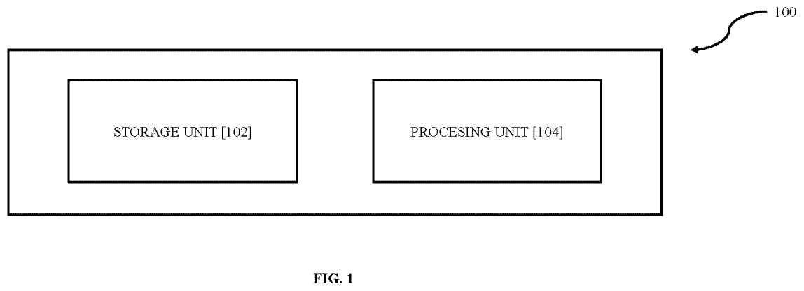

The manner in which a user specific content is generated is explained in detail with respect to FIGS. 1-3. It is to be noted that drawings of the present subject matter shown here are for illustrative purposes and are not to be construed as limiting the scope of the subject matter claimed.

Referring to FIG. 1 exemplary block diagram of a system [100] for generating a user specific content, in accordance with the exemplary embodiments of the present disclosure is illustrated. The system [100] comprises at least one storage unit [102] and at least one processing unit [104]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. In an implementation the system [100] may reside in a server connected to a user device. In another implementation the system [100] may reside in the user device. In another implementation, the system [100] may reside partially in the server and the user device in a manner as appreciated by a person skilled in the art in light of the present disclosure. In yet another implementation the system [100] may be in connection with the server and the user device in a manner as appreciated by a person skilled in the art in light of the present disclosure.

In operation for generating a user specific content the processing unit [104] receives a user specific input data, a base content, and an e-commerce data. In an implementation, the user specific input data is received as at least one of an automatic input, and a manual input from one or more users of the user device. The automatic input is the user specific input data received by the processing unit [104] automatically from a cloud storage. The user may integrate the cloud storage with the system [100] for automatic retrieval of input (e.g., user specific input data) from the cloud storage. Further, the manual input is the user specific input data shared by the user(s) manually for example through a quick response (QR) code. The user may scan the QR code to share the user specific data to the system [100]. Upon successful scan of the QR code the processing unit [104] may receive the user specific input data. It is pertinent to note that other means of providing manual input that may be appreciated by a person skilled in the art may also be considered to implement the features as disclosed in the present disclosure.

In an implementation, the user specific input data comprises a set of images related to at least one of a person, an animal, and an object and at least one of a user related data, a user preference data, a content usage pattern information, and a content engagement information. In an implementation, the processing unit [104] may also receive a text input data. The text input data may include one or more text strings that are descriptive in nature. In an implementation, the text input data may be generated automatically based on the user specific input data and the base content. Also, in an implementation, the text input data may be provided by the user(s) of the user device manually based on one or more specific parameters. The one or more specific parameters may include such as, but not limited to, clothes, background scene in an image, etc. Further, the text input data may be provided to the processing unit [104] at any time such as, at the start of the process of generating the user specific content, and/or as recommendation or a feedback after the user specific content is generated. Further, the user specific content is generated by transforming the received user specific input data and the base content into the user specific content.

Also, the base content is at least one of a visual media and an audio-visual media, related to at least one of a trending event, a news, a sport, a geographical area, a weather condition, an entertainment related event, an image of one or more users of the user device, and such other information as appreciated by a person skilled in the art in light of the present disclosure.

Further, the e-commerce data is related to the base content and the user specific input data. The e-commerce data may be received from an e-commerce catalog of the e-commerce platform for generating the user specific content. The e-commerce catalog comprises data related to a plurality of products available on the e-commerce platform. Thereby, based on the user specific data and the base content, the e-commerce data comprising details of product(s) relevant to the base content and the user specific input data is received from the e-commerce catalog for generating the user specific content.

Continuing further, the processing unit [104] is also configured to extract a set of features from the user specific input data. The set of features comprises at least one of a set of facial parameters, a set of age-related parameters, a set of gender related parameters, a set of environment related parameters, a set of non-human object related parameters, and a set of characteristics related parameters. The set of facial parameters comprises one or more parameters indicating one or more facial details related to an object such as the one or more users of the user device. The set of age-related parameters comprises one or more parameters indicating an age related information. The set of gender related parameters comprises one or more parameters indicating a gender related information. The set of environment related parameters comprises one or more parameters indicating an environment related information. The set of non-human object related parameters comprises one or more parameters indicating an information of non-human object(s). The set of characteristics related parameters comprises one or more parameters indicating an information related to characteristics of object(s). The set of features are extracted by the processing unit [104] using a first artificial intelligence based sub-system.

In an implementation, the first artificial intelligence based sub-system may be a personal reference image analyzer. The personal reference image analyzer may employ advanced vision model to analyse visual data such as the set of images provided by the user of the user device. The set of image may include image(s) of one or more individuals such as, but not limited to, the user, family member(s) of the user, friend(s) of the user and/or one or more animals etc. The personal reference image analyzer may extract key features related to the one or more individuals and/or the one or more animals present in the set of images provided by the user. The key features may include such as, but not limited to, one or more facial characteristics, age, and gender of the one or more individuals and/or the one or more animals present in the set of images provided by the user of the user device.

Considering an example where the set of images includes an image of a user A, a user B, a user C, and a user D. The personal reference image analyzer in such example may extract facial features providing details such as, but not limited to, the user A has beard, the user B has a round face, user C has a cut or mole on his face etc. Further, personal reference image analyzer may identify the age and the gender of the one or more individuals present in the set of images such as, but not limited to, the age of the user A is identified as 30 years and the user A is identified as a male, the age of the user B is identified as 29 years and the user B is also identified as a male, the age of the user C is identified as 32 years and the user C is identified as a female, and the age of the user D is identifies as 19 years and the user D is identified as is male.

Thus, in an implementation, the first artificial intelligence based sub-system is an age and gender identifier. The age and gender identifier may specifically identify the age and the gender of the one or more individuals in the set of images provided by the user of the user device to enhance the accuracy and personalization while generating the user specific content.

Continuing further, the processing unit [104] is configured to alter the base content based on the e-commerce data and the set of features. The received base content is transformed into an output media such as an output visual based on the set of features and the e-commerce data. Considering an example, a base content, say, an audio-video media related to a geographical area that includes a waterfall in a forest and a user specific input data including a set of images is received. The received set of images includes image(s) of one or more individuals including a user of a user device and family/friends of the user. Also, in this example one or more text inputs from the user of the user device is also received to generate a user specific content. Upon the receipt of the set of images, the set of features, such as, but not limited to age, gender, facial characteristics, etc. are extracted along with the e-commerce data. The received base content (e.g., audio-video media file) is then transformed into visuals that include the one or more individuals present in the set of images i.e., the visuals include such as, but not limited to, the one or more individuals present at the waterfall in the forest. Also, say, the text input includes a data indicating that the one or more individuals to be added in the visuals may be wearing tracking clothes. Thus, the transformed visuals may include the one or more individuals wearing the tracking cloths at the waterfall in the forest. Further, the visuals may also include the e-commerce data related to the base content and the user specific input data. The e-commerce data may include details such as, but not limited to, link to purchase the tracking clothes, etc.

Further, to alter the base content, the processing unit [104] is configured to generate one or more suggestions based on the user specific input data, using a second artificial intelligence based sub-system. The processing unit [104] is then configured to provide the one or more suggestions on the user device. Also, in an implementation, the user device is a smart television.

In an implementation, the second artificial intelligence based sub-system is a Gen AI Prompt generator. The Gen AI Prompt generator may generate one or more prompts based on the user specific input. The generated prompts may serve as instructions to generate one or more user specific contents. Furthermore, in an implementation, the one or more suggestions are one or more reverse prompts, that may suggest one or more modifications in the base content based on the user specific content indicating an interest of the user. Thus, by suggesting the user interest based modification(s) to be added in the base content, the one or more reverse prompts expose one or more new possibilities to the user to enhance an interactive experience of the user.

Furthermore, it is to be noted that the mentioned one or more suggestions are only exemplary and in no manner limiting the scope of the present disclosure.

Continuing further, the processing unit [104] is configured to receive, from the user device, a response to the one or more suggestions, and based on the received response form the user device the processing unit [104] then alters the base content. The processing unit [104] generates the user specific content based on the altering of the base content. The user specific content comprises at least one of a user specific visual media, and a user specific audio-visual media. In an implementation, the user specific content comprises one or more links to purchase one or more items visible in the user specific content. The one or more links are added during the altering of the base content, and the one or more links are identified based on the e-commerce data. For example, the processing unit [104] may generate one or more suggestions (i.e., the one or more reserves prompt) such as, “would you like to see a memory in an autumn setting?”, “imagine a scenario in a futuristic cityscape”, etc. Thereafter, based on a user selection of such reserve prompt, a corresponding base content is modified by the processing unit [104] as per the reverse prompt to generate a user specific content. The generated user specific content may also include one or more links to purchase one or more items visible in the user specific content, the one or more items for example may include clothes, shoes, a music instrument, and/or the like.

Further, in an implementation, to add in the base content, the one or more links to purchase the one or more items visible in the user specific content, the system [100] may use an enhanced object detection technique. The enhanced object detection technique may detect and analyse not only human subject(s) but also the non-human object(s) in the set of images related to at least one of the person, the animal, and the object. The non-human objects may include such as, but not limited to, surroundings, clothing, home furniture, etc. The analysis of both the human subject(s) and the non-human object(s) may generate more comprehensive and contextually accurate user specific content.

Next, upon identification of the non-human object(s) using the enhanced object detection technique, the system [100] may search the e-commerce catalog to find one or more products that matches the identified one or more non-human objects. Thereafter, a link to purchase the one or more products that matches the identified one or more non-human objects, is added in the base content during altering the base content for generation of the user specific content. Also, in an implementation, while altering the base content, a quick response (QR) code may be added for said link along with the one or more matched products to purchase the one or more matched products via the user specific content.

Moreover, in an implementation, the user specific content comprises one or more advertisements (Ads). The one or more Ads are added during the altering the base content, and the one or more Ads are identified based on at least one of the user specific input data, the base content, and the e-commerce data.

Also, in an implementation, the processing unit [104] is configured to provide the generated user specific content on the user device and thereafter the processing unit [104] is configured to receive, from the user device, a user feedback on one or more portions of the generated user specific content. For instance, the user may provide the feedback to improve the generated user specific content based on one or more specific parameters. The one or more specific parameters may include such as, but not limited to, body type, image style, object(s) in the generated user specific content, etc. Thereafter, the processing unit [104] is configured to update the generated user specific content based on the user feedback. Also, the generated user specific content may be updated and re-generated back in real-time based on the user feedback.

Moreover, in an implementation, for generating the user specific content, the processing unit [104] is configured to perform a suitability check for the user specific content. The suitability check is performed based on checking if any information related to the user specific input data and the base content is mapping to a set of pre-defined critical issues to confirm that the user specific input data and the base content are eligible for transformation into the user specific content. Considering an example, a base content, say, a news that is related to an issue that maps to a critical issue in the set of pre-defined critical issues, or any sensitive statement given by a politician that is mapping to a critical issue in the set of pre-defined critical issues, is not considered suitable for the transformation into the user specific content, as it may lead to a serious issue.

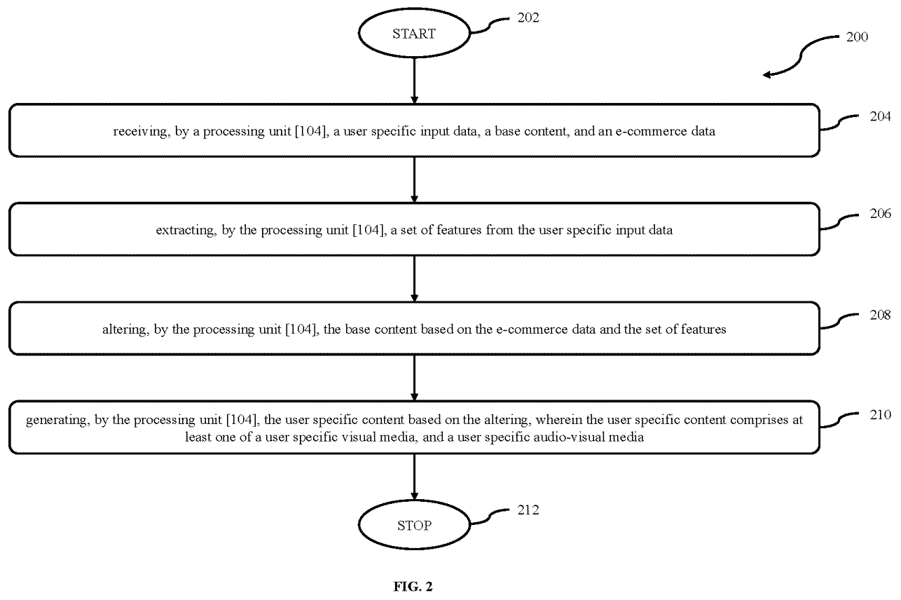

Referring to FIG. 2 exemplary flow diagram of a method [200] for generating user specific content, in accordance with the exemplary embodiments of the present disclosure is illustrated. In an implementation the method [200] is performed by a system [100]. The method as depicted in FIG. 2 starts at step [202].

At step [204], the method [200] comprises receiving, by a processing unit [104], a user specific input data, a base content, and an e-commerce data. In an implementation, the user specific input data is received as at least one of an automatic input, and a manual input from one or more users of the user device. The automatic input is the user specific input data received by the processing unit [104] automatically from a cloud storage. The user may integrate the cloud storage with the system [100] for automatic retrieval of input (e.g., user specific input data) from the cloud storage. Further, the manual input is the user specific input data shared by the user(s) manually for example through a quick response (QR) code. The user may scan the QR code to share the user specific data to the system [100]. Upon successful scan of the QR code the processing unit [104] may receive the user specific input data. It is pertinent to note that other means of providing manual input that may be appreciated by a person skilled in the art may also be considered to implement the features as disclosed in the present disclosure.

In an implementation, the user specific input data comprises a set of images related to at least one of a person, an animal, and an object and at least one of a user related data, a user preference data, a content usage pattern information, and a content engagement information. In an implementation, the processing unit [104] may also receive a text input data. The text input data may include one or more text strings that are descriptive in nature. In an implementation, the text input data may be generated automatically based on the user specific input data and the base content. Also, in an implementation, the text input data may be provided by the user(s) of the user device manually based on one or more specific parameters. The one or more specific parameters may include such as, but not limited to, clothes, background scene in an image, etc. Further, the text input data may be provided to the processing unit [104] at any time such as, at the start of the process of generating the user specific content, and/or as recommendation or a feedback after the user specific content is generated. Further, the user specific content is generated by transforming the received user specific input data and the base content into the user specific content.

Also, the base content is at least one of a visual media and an audio-visual media, related to at least one of a trending event, a news, a sport, a geographical area, a weather condition, an entertainment related event, and an image of one or more users of the user device, and such other information as appreciated by a person skilled in the art in light of the present disclosure.

Further, the e-commerce data is related to the base content and the user specific input data. The e-commerce data may be received from an e-commerce catalog of the e-commerce platform for generating the user specific content. The e-commerce catalog comprises data related to a plurality of products available on the e-commerce platform. Thereby, based on the user specific data and the base content, the e-commerce data comprising details of product(s) relevant to the base content and the user specific input data is received from the e-commerce catalog for generating the user specific content.

Next, at step [206], the method [200] comprises extracting, by the processing unit [104], a set of features from the user specific input data. The set of features comprises at least one of a set of facial parameters, a set of age-related parameters, a set of gender related parameters, a set of environment related parameters, a set of non-human object related parameters, and a set of characteristics related parameters. The set of facial parameters comprises one or more parameters indicating one or more facial details related to an object such as the one or more users of the user device. The set of age-related parameters comprises one or more parameters indicating an age related information. The set of gender related parameters comprises one or more parameters indicating a gender related information. The set of environment related parameters comprises one or more parameters indicating an environment related information. The set of non-human object related parameters comprises one or more parameters indicating an information of non-human object(s). The set of characteristics related parameters comprises one or more parameters indicating an information related to characteristics of object(s). The set of features are extracted by the processing unit [104] using a first artificial intelligence based sub-system.

In an implementation, the first artificial intelligence based sub-system may be a personal reference image analyzer. The personal reference image analyzer may employ advanced vision model to analyse visual data such as the set of images provided by the user of the user device. The set of image may include image(s) of one or more individuals such as, but not limited to, the user, family member(s) of the user, friend(s) of the user and/or one or more animals etc. The personal reference image analyzer may extract key features related to the one or more individuals and/or the one or more animals present in the set of images provided by the user. The key features may include such as, but not limited to, one or more facial characteristics, age, and gender of the one or more individuals and/or the one or more animals present in the set of images provided by the user of the user device.

Further, at step [208], the method [200] comprises altering, by the processing unit [104], the base content based on the e-commerce data and the set of features. The received base content is transformed into an output media such as an output visual(s) based on the set of features and the e-commerce data.

Further, to alter the base content, the processing unit [104] generates one or more suggestions based on the user specific input data, using a second artificial intelligence based subsystem. The processing unit [104] then provides the one or more suggestions on the user device. Also, in an implementation, the user device is a smart television.

In an implementation, the second artificial intelligence based sub-system is a Gen AI Prompt generator. The Gen AI Prompt generator may generate one or more prompts based on the user specific input. The generated prompts may serve as instructions to generate one or more user specific contents. Furthermore, in an implementation, the one or more suggestions are one or more reverse prompts, that may suggest one or more modifications in the base content based on the user specific content indicating an interest of the user. Thus, by suggesting the user interest based modification(s) to be added in the base content, the one or more reverse prompts expose one or more new possibilities to the user to enhance an interactive experience of the user.

Continuing further, in an implementation, the processing unit [104] receives, from the user device, a response to the one or more suggestions, and based on the received response form the user device the processing unit [104] then alters the base content.

Furthermore, at step [210], the method [200] comprises generating, by the processing unit [104], the user specific content based on the altering, wherein the user specific content comprises at least one of a user specific visual media, and a user specific audio-visual media. In an implementation, the user specific content comprises one or more links to purchase one or more items visible in the user specific content. The one or more links are added during the altering of the base content, and the one or more links are identified based on the e-commerce data.

Further, in an implementation, to add in the base content, the one or more links to purchase the one or more items visible in the user specific content, the method may encompass using enhanced object detection technique. The enhanced object detection technique may detect and analyse not only human subject(s) but also the non-human object(s) in the set of images related to at least one of the person, the animal, and the object. The non-human objects may include such as, but not limited to, surroundings, clothing, home furniture, etc. The analysis of both the human subject(s) and the non-human object(s) may generate more comprehensive and contextually accurate user specific content.

Next, upon identification of the non-human object(s) using the enhanced object detection technique, the system [100] may search the e-commerce catalog to find one or more products that matches the identified one or more non-human objects. Thereafter, a link to purchase the one or more products that matches the identified one or more non-human objects, is added in the base content during altering the base content for generation of the user specific content. Also, in an implementation, while altering the base content, a quick response (QR) code may be added for said link along with the one or more matched products to purchase the one or more matched products via the user specific content.

Moreover, in an implementation, the user specific content comprises one or more advertisements (Ads). The one or more Ads are added during the altering the base content, and the one or more Ads are identified based on at least one of the user specific input data, the base content, and the e-commerce data.

Also, in an implementation, the processing unit [104] provides the generated user specific content on the user device and thereafter receives, from the user device, a user feedback on one or more portions of the generated user specific content. For instance, the user may provide the feedback to improve the generated user specific content based on one or more specific parameters. The one or more specific parameters may include such as, but not limited to, body type, image style, object(s) in the generated user specific content, etc. Thereafter, the processing unit [104] updates the generated user specific content based on the user feedback. Also, the generated user specific content may be updated and re-generated back in real-time based on the user feedback.

Moreover, in an implementation, for generating the user specific content, the method encompasses performing by the processing unit [104] a suitability check for the user specific content. The suitability check is performed based on checking if any information related to the user specific input data and the base content is mapping to a set of pre-defined critical issues to confirm that the user specific input data and the base content are eligible for transformation into the user specific content. Considering an example, a base content, say, a news that is related to an issue that maps to a critical issue in the set of pre-defined critical issues or any sensitive statement given by a politician that is mapping to a critical issue in the set of pre-defined critical issues, is not considered suitable for the transformation into the user specific content, as it may lead to serious issue.

Thereafter, at step [212], the method [200] may terminate.

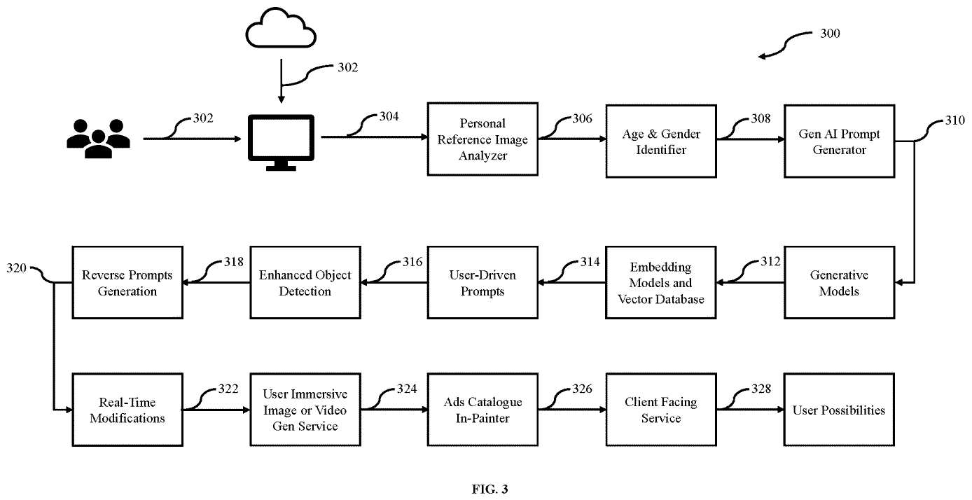

Referring to FIG. 3 an exemplary flow diagram for generating user specific content, in accordance with the exemplary embodiments of the present disclosure is illustrated.

At step [302], a user uploads at the system [100], a set of images that may act as a foundational reference to generate one or more personalized visuals (i.e., one or more user specific contents). The set of images may be uploaded by the user manually by scanning the quick response (QR) code or may be received from a cloud storage automatically by integrating the cloud storage.

Next, at step [304], the set of images are sent to a personal reference image analyzer. The personal reference image analyzer employs advanced Vision Models to analyse the set of images, an in an implementation it extracts key features such as facial characteristics, age, and gender etc. from the set of images. In an implementation, this analysis and/or extraction at this step, results in dynamic template(s) that guide subsequent processing steps.

Next at step [306], the set of images and/or the dynamic template(s) are sent to an age and gender identifier models. The age and gender identifier models specifically identify the age and gender of individuals within the uploaded images, enhancing the accuracy and personalization of the generated visuals.

Further, at step [308], the set of images and/or the dynamic template(s) are sent to gen AI prompt generator. The gen AI prompt generator creates detailed prompts based on the output received from the personal reference image analyzer and/or the age and gender identifier models. The generated prompts are derived from the set of images and one or more descriptive text inputs. The generated prompts serve as one or more instructions for the generative models.

Further, at step [310], the set of images and the generated prompts are sent to one or more generative models. The one or more generative models generate a final visual content. The one or more generative models use the prompts provided by the gen AI prompt generator to produce highly personalized and contextually relevant images and videos.

Furthermore, at step [312], the generated final visual content is sent to one or more embedding models and a vector database. The one or more embedding models convert image(s) and template(s) corresponding to the final visual content into one or more vector embeddings, facilitating efficient retrieval and matching processes. Further, the vector database stores the one or more vector embeddings, enabling quick access to one or more relevant templates and one or more embeddings needed for a content generation (i.e., for generating the user specific content).

Next, at step [314], the user provides one or more prompts in form of one or more descriptive text inputs that outlines their desired scenarios or modifications in the generated final visual content. The one or more user prompts guide the generative models in creating personalized visuals. For example, the one or more user prompts may include such as, but not limited to, “Imagine me and my wife getting married on the moon,” “Show me celebrating a birthday with my grandparents.,” etc.

Further, at step [316], system for modifications in the generated final visual content employs enhanced object detection technique to detect and analyse not only human subjects but also non-human objects in the set of images. The non-human object includes such as, but not limited to, surroundings, clothing, home furniture, and other objects present in the set of images.

Further, at step [318], one or more reverse prompts are generated based on the user interactions and preferences. The one or more reverse prompts suggest further modifications or scenarios that the user might find interesting. The one or more reverse prompts are designed to expose users to new possibilities and enhance the interactive experience.

Further, at step [320], real-time modifications are added in the generated final visual content. Thus, the users can interact with the system [100] in real-time through their connected TV. The users may provide new prompts or modify existing final visual content, prompting the system [100] to adjust the generated visuals accordingly. The user interaction ensures that users have continuous control over the personalization of their content.

Further, at step [322], the user may use one or more services provided by the system to enhance the user-generated content. The one or more services includes multiple functionalities such as a story generation, a personalized image editing, teleporting to virtual places, commerce templates i.e., integrating product catalogues to enable e-commerce functionalities and different artificial intelligence (AI) based art forms.

Furthermore, at step [324], once the user selects an advertisement based service provided by the system [100], an ads catalogue in-painter integrates advertisement(s) at relevant places into the generated visuals/final visual content.

Thereafter, at step [326], a client facing service ensures that the final visual content e.g., final generated images and videos are delivered to the user. It utilizes the cloud storage and one or more distribution mechanisms to make the content accessible on users' devices.

Moreover, at step [328], user possibilities (e.g., virtual presence of a user) in one or more generated visual contents as a final output are experienced by the user, through their connected TV or other devices. The one or more possibilities showcases the AI-generated visuals and scenarios, offering an interactive and immersive experience.

Yet another object of the present disclosure may relate to a non-transitory computer readable storage medium storing one or more instructions for generating a user specific content, the instructions include executable code which, when executed by one or more units of a system [100], causes a processing unit [104] of the system [100] to receive a user specific input data, a base content and an e-commerce data. Further, the executable code when executed causes the processing unit [104] to extract a set of features from the user specific input data. Further, the executable code when executed causes the processing unit [104] to alter the base content based on the e-commerce data and the set of features. Furthermore, the executable code when executed causes the processing unit [104] to generate the user specific content based on the altering, wherein the user specific content comprises at least one of a user specific visual media, and a user specific audio-visual media.

Therefore, the present disclosure provides a technical solution for generating a user specific content. More specifically, the present disclosure overcomes the existing problems in the field of technology by generating a user specific content. Further, the present disclosure provides a solution that generates user specific content through which the user may virtually experience the real-life moments and imagine a future scenario and/or fantasies. Also, the present disclosure provides a solution that generates user specific content that provides users an experience to relive the memories of the past in present. Further, the present disclosure provides a solution that generates personalized visuals related to content preferred by a user, with the user being a part of the visuals. Further, the present disclosure provides a solution that generates user specific content encompassing buying links of non-human objects in the user specific content that the user may want to purchase.

While considerable emphasis has been placed herein on the disclosed implementations, it will be appreciated that many implementations can be made and that many changes can be made to the implementations without departing from the principles of the present disclosure. These and other changes in the implementations of the present disclosure will be apparent to those skilled in the art, whereby it is to be understood that the foregoing descriptive matter to be implemented is illustrative and non-limiting.

We claim:

1. A method for generating a user specific content, the method comprises:
receiving, by a processing unit, a user specific input data, a base content, and an e-commerce data;
extracting, by the processing unit, a set of features from the user specific input data;
altering, by the processing unit, the base content based on the e-commerce data and the set of features; and
generating, by the processing unit, the user specific content based on the altering, wherein the user specific content comprises at least one of a user specific visual media, and a user specific audio-visual media.

2. The method as claimed in claim 1, wherein the e-commerce data is related to the base content and the user specific input data.

3. The method as claimed in claim 1, wherein the base content is at least one of a visual media and an audio-visual media, related to at least one of a trending event, a news, a sport, a geographical area, a weather condition, an entertainment related event, and an image of one or more users of a user device.

4. The method as claimed in claim 1, wherein the user specific input data is received as at least one of an automatic input, and a manual input from one or more users of a user device, and wherein the user specific input data comprises a set of images related to at least one of a person, an animal, and an object and at least one of a user related data, a user preference data, a content usage pattern information, and a content engagement information.

5. The method as claimed in claim 1, wherein the set of features comprises at least one of a set of facial parameters, a set of age-related parameters, a set of gender related parameters, a set of environment related parameters, a set of non-human object related parameters, and a set of characteristics related parameters.

6. The method as claimed in claim 1, wherein the set of features are extracted by the processing unit using a first artificial intelligence based sub-system.

7. The method as claimed in claim 1, wherein the altering, by the processing unit, the base content further comprises:
generating, by the processing unit using a second artificial intelligence based sub-system, one or more suggestions based on the user specific input data,
providing, by the processing unit, the one or more suggestions on a user device,
receiving, by the processing unit from the user device, a response to the one or more suggestions, and
altering, by the processing unit, the base content based on the response.

8. The method as claimed in claim 1, wherein the user specific content comprises one or more links to purchase one or more items visible in the user specific content, and wherein the one or more links are added during the altering, and the one or more links are identified based on the e-commerce data.

9. The method as claimed in claim 1, wherein the user specific content comprises one or more advertisements (Ads), and wherein the one or more Ads are added during the altering, and the one or more Ads are identified based on at least one of the user specific input data, the base content, and the e-commerce data.

10. The method as claimed in claim 1, the method comprises:
providing, by the processing unit, the generated user specific content on a user device,
receiving, by the processing unit from the user device, a user feedback on one or more portions of the generated user specific content, and
updating, by the processing unit, the generated user specific content based on the user feedback.

11. The method as claimed in claim 10, wherein the user device is a smart television.

12. The method as claimed in claim 1, wherein for generating the user specific content, the method comprises performing a suitability check for the user specific content.

13. A system for generating a user specific content, the system comprises:
a storage unit; and
a processing unit connected to at least the storage unit, the processing unit is configured to:
receive a user specific input data, a base content, and an e-commerce data,
extract a set of features from the user specific input data,
alter the base content based on the e-commerce data and the set of features, and
generate the user specific content based on the altering, wherein the user specific content comprises at least one of a user specific visual media, and a user specific audio-visual media.

14. The system as claimed in claim 13, wherein the e-commerce data is related to the base content and the user specific input data.

15. The system as claimed in claim 13, wherein the base content is at least one of a visual media and an audio-visual media, related to at least one of a trending event, a news, a sport, a geographical area, a weather condition, an entertainment related event, and an image of one or more users of a user device.

16. The system as claimed in claim 13, wherein the user specific input data is received as at least one of an automatic input, and a manual input from one or more users of a user device, and wherein the user specific input data comprises a set of images related to at least one of a person, an animal, and an object and at least one of a user related data, a user preference data, a content usage pattern information, and a content engagement information.

17. The system as claimed in claim 13, wherein the set of features comprises at least one of a set of facial parameters, a set of age-related parameters, a set of gender related parameters, a set of environment related parameters, a set of non-human object related parameters, and a set of characteristics related parameters.

18. The system as claimed in claim 13, wherein the set of features are extracted by the processing unit using a first artificial intelligence based sub-system.

19. The system as claimed in claim 13, wherein the processing unit to alter the base content is configured to:
generate, one or more suggestions based on the user specific input data, using a second artificial intelligence based sub-system,
provide, the one or more suggestions on a user device,
receive, from the user device, a response to the one or more suggestions, and
alter the base content based on the response.

20. The system as claimed in claim 13, wherein the user specific content comprises one or more links to purchase one or more items visible in the user specific content, and wherein the one or more links are added during the altering, and the one or more links are identified based on the e-commerce data.

21. The system as claimed in claim 13, wherein the user specific content comprises one or more advertisements (Ads), and wherein the one or more Ads are added during the altering, and the one or more Ads are identified based on at least one of the user specific input data, the base content, and the e-commerce data.

22. The system as claimed in claim 13, wherein the processing unit is further configured to:
provide the generated user specific content on a user device,
receive, from the user device, a user feedback on one or more portions of the generated user specific content, and
update the generated user specific content based on the user feedback.

23. The system as claimed in claim 22, wherein the user device is a smart television.

24. The system as claimed in claim 13, wherein for generating the user specific content, the processing unit is configured to perform a suitability check for the user specific content.
